(19) United States
(12) Patent Application Publication
(10) Pub. No.: US 2017/0072818 A1
(43) Pub. Date: Mar. 16, 2017

(54) SEAT RECLINING DEVICE

(71) Applicant: AISIN SEIKI KABUSHIKI KAISHA, Kariya-shi (JP)

(72) Inventors: Mikihito NAGURA, Okazaki-shi (JP); Atsushi ABAKA, Kariya-shi (JP)

(73) Assignee: AISIN SEIKI KABUSHIKI KAISHA, Kariya-shi (JP)

(21) Appl. No.: 15/120,332

(22) PCT Filed: Feb. 20, 2015
(86) PCT No.: PCT/JP2015/054757

§ 371 Date: Aug. 19, 2016

(30) Foreign Application Priority Data
Feb. 24, 2014 (JP) 2014-033326

(51) Int. Cl. B60N 2/235

(52) U.S. Cl. CPC B60N 2/236

(57) ABSTRACT

A seat reclining device includes a first bracket, a second bracket that is rotatable relative to the first bracket, a cam that is rotatable relative to the first bracket, and pawls moved in a radial direction of the first bracket and engaged with the second bracket by rotation of the cam. The first bracket includes a guide, which guides the pawls in the radial direction, and a restriction portion, which is provided in correspondence with at least one of the pawls and which restricts movement of the corresponding pawl in a circumferential direction. The pawl corresponding to the restriction portion includes a contact portion that contacts the restriction portion when the pawl moves. The contact portion is spaced apart by a gap from the restriction portion.

### TECHNICAL FIELD

The present invention relates to a seat reclining device.

### BACKGROUND ART

Patent document 1 describes an example of a seat reclining device that holds a seatback at a predetermined angle relative to a seat cushion.

A seat reclining device includes a first bracket that is coupled to the seat cushion, a cam that is rotated relative to the first bracket, pawls moved in the radial direction of the first bracket by the rotation of the cam, and a second bracket that is coupled to the seatback and rotated relative to the first bracket. The rotation of the cam moves the pawls toward the outer side so that the outer teeth of each pawl engages with the inner teeth on the outer circumferential wall of the second bracket and restricts rotation of the second bracket. This keeps the rotation angle of the second bracket relative to the first bracket at a predetermined angle.

### PRIOR ART DOCUMENT

### Patent Document

Patent Document 1: Japanese Laid-Out Patent Publication No. 2008-543387

### SUMMARY OF THE INVENTION

### Problems that are to be Solved by the Invention

The force of an impact may be applied to the seat reclining device.

For example, when the vehicle is hit from the rear, the impact may force the vehicle occupant toward the rear. This applies a strong force to the seatback. As a result, impact force is applied to the seat reclining device that fixes the seatback at a predetermined angle.

When such an impact force is applied to the seat reclining device, a pawl of the seat reclining device may be plastically deformed. When a pawl is plastically deformed, the operation of the seat reclining device is adversely affected.

It is an object of the present invention to provide a seat reclining device that limits plastic deformation of a pawl.

### Means for Solving the Problem

A seat reclining device that solves the above problem includes a first bracket, a second bracket that is rotatable relative to the first bracket, a cam that is rotatable relative to the first bracket, and pawls moved in a radial direction of the first bracket and engaged with the second bracket by rotation of the cam. The first bracket includes a guide, which guides the pawls in the radial direction, and a restriction portion, which is provided in correspondence with at least one of the pawls and which restricts movement of the corresponding pawl in a circumferential direction. The pawl corresponding to the restriction portion includes a contact portion that contacts the restriction portion when the pawl moves. The contact portion is spaced apart by a gap from the restriction portion.

### BRIEF DESCRIPTION OF THE DRAWINGS

FIG. 1 is a side view of a seat including one embodiment of a seat reclining device.

FIG. 2 is a cross-sectional view taken along line II-II in FIG. 1.

FIG. 3 is an exploded perspective view of the seat reclining device shown in FIG. 2.

FIG. 4A is a plan view of a first bracket shown in FIG. 3, and FIG. 4B is a side view of FIG. 4A.

FIG. 5 is a plan view of a cam shown in FIG. 3.

FIG. 6 is a perspective view of a first pawl shown in FIG. 3.

FIG. 7 is a perspective view of a second pawl shown in FIG. 3.

FIG. 8A is a plan view of the second pawl shown in FIG. 7, and FIG. 8B is a side view of FIG. 8A.

FIG. 9A is a plan view of the second bracket shown in FIG. 3, and FIG. 9B is a cross-sectional view taken along line IX-IX in FIG. 9A.

FIG. 10A is a schematic diagram showing the seat reclining device in a locked state, FIG. 10B is a schematic diagram showing the seat reclining device in an unlocked state, and FIG. 10C is a schematic diagram showing the seat reclining device in a lock-disabled state.

FIG. 11 is an enlarged plan view showing a portion where the second pawl is located in the seat reclining device of FIG. 2.

FIG. 12 is a cross-sectional view taken along line XII-XII in FIG. 11.

FIG. 13 is a partial cross-sectional view showing a modified example of a seat reclining device.

### EMBODIMENTS OF THE INVENTION

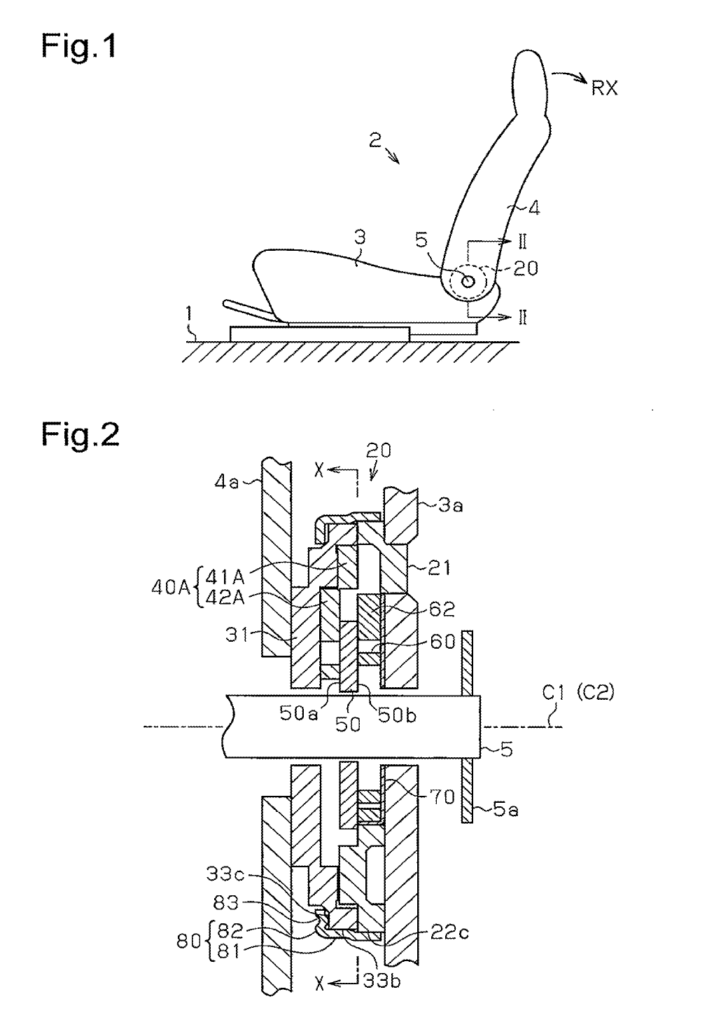

One embodiment of a seat reclining device 20 will now be described with reference to FIGS. 1 to 12.

As shown in FIG. 1, the seat reclining device 20 is applied to a seat 2 that is arranged on, for example, a vehicle floor 1. For example, the seat 2 includes a seat cushion 3 and a seatback 4, and the seatback 4 is pivotal relative to the seat cushion 3 and can be maintained at a predetermined angle relative to the seat cushion 3.

The seatback 4 is coupled to the seat cushion 3 by the seat reclining device 20. The seat reclining device 20 maintains the seatback 4 at a predetermined angle relative to the seat cushion 3.

A plate 3a shown in FIG. 2 is coupled to the seat cushion 3, and a plate 4a shown in FIG. 2 is coupled to the seatback 4. As shown in FIG. 2, the seat reclining device 20 includes rotors (first and second brackets 21 and 31 that will be described later), one of which is fixed to the plate 3a and the other of which is fixed to the plate 4a. In this embodiment, as shown in FIG. 2, the first bracket 21 is fixed to the plate 3a, and the second bracket 31 is fixed to the plate 4a.

As shown in FIGS. 1 and 2, a shaft 5 is inserted through the central portion of the seat reclining device 20. The shaft 5 actuates a cam mechanism located in the seat reclining device 20. An operation lever 5a is coupled to one end of the shaft 5 to rotate the shaft 5.

When the seat reclining device 20 is coupled to the seat 2, the rotation axis C1 of the shaft 5 coincides with the rotation axis C2 of the seat reclining device 20 (rotation axes of first bracket 21 and second bracket 31).

In the description hereafter, the direction extending around the rotation axis C2 of the seat reclining device 20 is referred to as the circumferential direction, and a direction orthogonal to the rotation axis C2 (normal direction) is referred to as the radial direction. When inclining the seatback 4 toward the rear, the direction in which the second bracket 31 rotates is referred to as the reverse rotation direction RX.

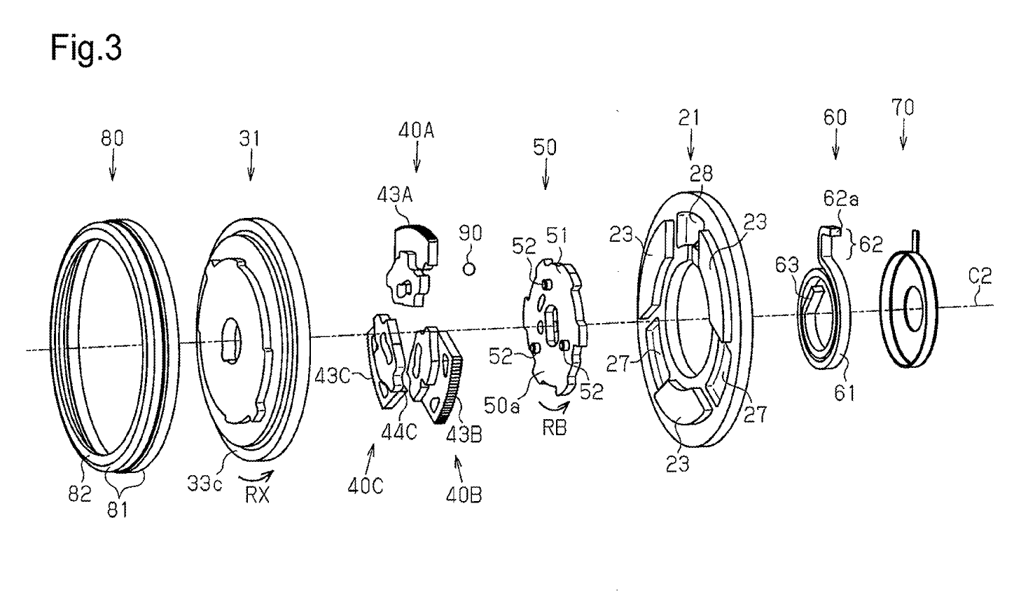

With reference to FIG. 3, the structure of the seat reclining device 20 will now be described.

As shown in FIG. 3, the seat reclining device 20 includes the first bracket 21, the second bracket 31, first to third pawls 40A to 40C, a cam 50, a spiral spring 60 that biases the cam 50, a cover 70 arranged around the spiral spring 60, and a retainer 80 that holds the first and second brackets 21 and 31. The seat reclining device 20 includes a ball cam 90 to restrict excessive movement of the first pawl 40A. The cam mechanism is formed by the cam 50, the spiral spring 60, the first to third pawls 40A to 40C, and the ball cam 90.

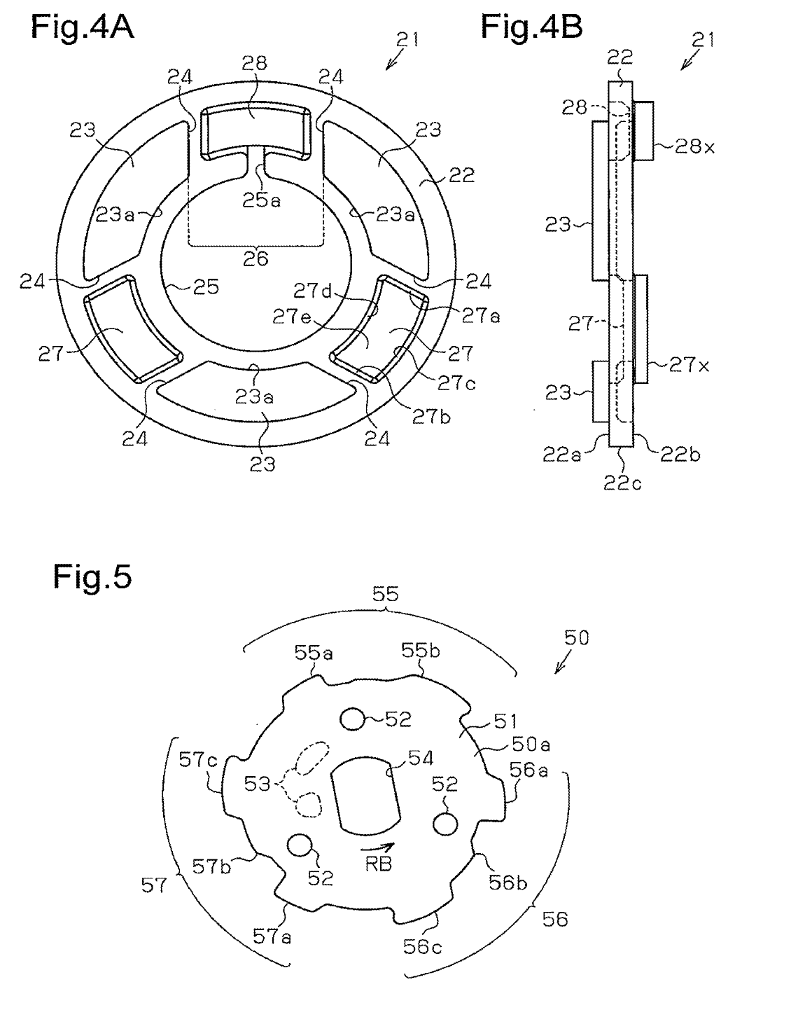

With reference to FIGS. 4A and 4B, the first bracket 21 will now be described.

As shown in FIGS. 4A and 4B, the first bracket 21 includes a disk-shaped main body 22, three guides 23 that guide the movement of the pawls 40A, 40B, and 40C, two restriction portions 27 that restrict movement of the pawls 40B and 40C in the circumferential direction, and an accommodation recess 28 that accommodates an end 62a of the spiral spring 60.

As shown in FIGS. 3 and 4B, the main body 22 includes an inner surface 22a that opposes the second bracket 31. The guides 23 project from the inner surface 22a of the main body 22.

As shown in FIGS. 2 and 4A, each guide 23 includes an inside surface 23a and two guide surfaces 24, which extend toward the outer side in the radial direction from the two circumferential ends of the inside surface 23a. The region surrounded by the inside surfaces 23a of the three guides 23 accommodate the cam 50.

The two opposing guide surfaces 24 of two adjacent guides 23 are parallel to each other. The opposing guide surfaces 24 cooperate with the inner surface 22a of the main body 22 to form a guide groove 26. The guide grooves 26 guide the pawls 40A, 40B, and 40C that move in the radial direction.

The three guides 23 are identical in shape and arranged at equal intervals in the circumferential direction. That is, the three guide grooves 26 are arranged at equal intervals in the circumferential direction. The surface at the opposite side of the guides 23 (outer surface 22b of main body 22) includes sunken portions in correspondence to the guides 23.

The restriction portions 27 are defined by the guide groove 26 to which the second pawl 40B is attached and the guide groove 26 to which the third pawl 40C is attached. Each restriction portion 27 has a recess structure formed by a recess in the inner surface 22a of the main body 22. For example, the restriction portion 27 is a recess including a lower surface 27e and first to fourth wall surfaces 27a to 27d extending at a right angle from the edges of the lower surface 27e.

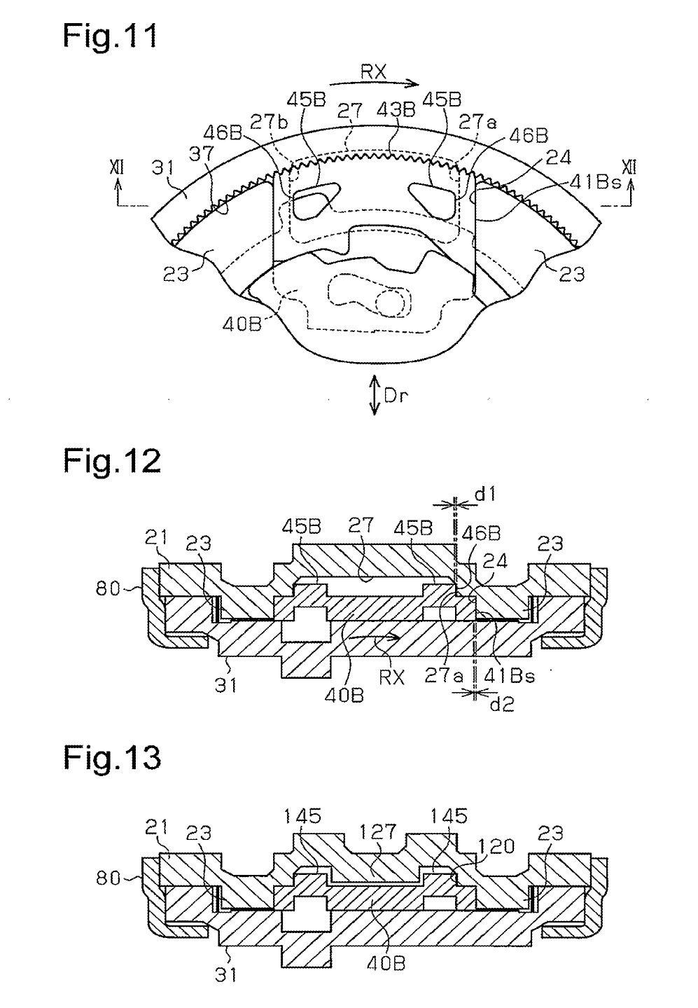

The first wall surface 27a (restriction surface) defines a front surface of the recess. The front surface refers to the surface located at the front side with respect to a rear rotation direction RX of the second bracket 31 (refer to FIGS. 1 and 3) when the second bracket 31 is rotated as the seatback 4 is inclined toward the rear. The first wall surface 27a is configured to extend in the movement direction Dr (refer to FIG. 11) of the second pawl 40B (or third pawl 40C) that moves in the radial direction. Further, the first wall surface 27a is configured to be parallel to a contact surface 46B (first contact surface, refer to FIG. 11) of a contact portion 45B, which will be described later, of the second pawl 40B (or third pawl 40C).

The second wall surface 27b (restriction surface) is arranged opposing the first wall surface 27a (restriction surface). In the same manner as the first wall surface 27a, the second wall surface 27b is configured to extend in the movement direction Dr (refer to FIG. 11) of the second pawl 40B (or third pawl 40C) that moves in the radial direction. Further, the second wall surface 27b is configured to be parallel to a contact surface 46B (second contact surface, refer to FIG. 11) of the contact portion 45B, which will be described later, of the second pawl 40B (or third pawl 40C).

The third wall surface 27c is arcuate and forms the radially outer surface of the recess.

The fourth wall surface 27d is arcuate and forms the radially inner surface of the recess. The third wall surface 27c and the fourth wall surface 27d are not limited to arcuate shapes.

Two projections 27x, which respectively correspond to the recess structures of the restriction portions 27, are located on the surface opposite to the restriction portions (outer surface 22b of first bracket 21). That is, the first bracket 21 includes the projections 27x that project from the outer surface 22b in correspondence to the restriction portions 27. In other words, the first bracket 21 includes the projections 27x that project from the outer surface 22b, which is located at the opposite side, in the direction of the rotation axis C2, from the inner surface 22a that includes the restriction portions 27.

The projections 27x are used as coupling portions of the first bracket 21. For example, the projections 27X are fitted into or engaged with holes or slots located in the plate 3a of the seat cushion 3. Further, when the first bracket 21 is coupled to the fixed member (e.g., plate 3a), the projections 27x are welded to the fixed member.

Among the three guide grooves 26, the guide groove 26 that receives the first pawl 40A includes the accommodation recess 28.

The accommodation recess 28 has the same structure as the restriction portions 27. The surface opposite to the accommodation recess 28 (outer surface 22b of first bracket 21) includes a projection 28x that projects in correspondence with the recess structure of the accommodation recess 28. That is, the first bracket 21 includes the projection 28x that projects from the outer surface 22b in correspondence with the accommodation recess 28. The projection 28x is used as a coupling portion of the first bracket 21 in the same manner as the projection 27x.

The central portion of the main body 22 defines an accommodation portion 25 that accommodates a spiral portion 61 of the spiral spring 60.

A communication groove 25a connects the accommodation portion 25 to the accommodation recess 28 of the first bracket 21. The spiral spring 60 includes an outer engagement portion 62 (refer to FIG. 3) engaged with a region extending over the communication groove 25a and the accommodation recess 28.

Stamping is performed to form the first bracket 21.

For example, stamping is performed on a metal plate using a set of dies to form the guides 23, the sunken structures at the opposite side of the guides 23, the restriction portions 27, the projections 27x at the opposite side of the restriction portions 27, the accommodation recess 28, and the projection 28x at the opposite side of the accommodation recess 28.

The structure of the cam 50 will now be described with reference to FIG. 5.

The cam 50 is located between the first and second brackets 21 and 31 (refer to FIG. 2). Further, the cam 50 is accommodated in a region surrounded by the inside surfaces 23a of the three guides 23 of the first bracket 21.

The cam 50 includes a cam body 51, three pawl engagement portions 52, and two spring engagement portions 53. The three pawl engagement portions 52 are respectively engaged with the first to third pawls 40A to 40C. The two spring engagement portions 53 are engaged with an inner engagement portion 63 of the spiral spring 60 (refer to FIG. 3). Each pawl engagement portion 52 projects from one surface (first surface 50a) of the cam 50, and each spring engagement portion 53 is arranged on the other surface (second surface 50b) of the cam 50 (refer to FIG. 2).

The central portion of the cam body 51 includes a fitting hole 54. The shaft 5 is fitted to the fitting hole 54. The cam 50 moves in cooperation with the rotation of the shaft 5. More specifically, operation of the operation lever 5a, which is coupled to the shaft 5, rotates the cam 50.

The circumferential surface of the cam body 51 includes three cam portions (hereafter referred to as the first cam portion 55, the second cam portion 56, and the third cam portion 57) that are arranged at equal angular intervals. The cam portions 55 to 57 respectively contact cam surfaces 44A to 44C of the pawls 40A to 40C, which will be described later.

The first cam portion 55 includes two pushing sections 55a and 55b that push the first cam surface 44A of the first pawl 40A.

The second cam portion 56 includes three pushing sections 56a, 56b, and 56c that push the second cam surface 44B of the second pawl 40B.

The third cam portion 57 includes three pushing sections 57a, 57b, and 57c that push the third cam surface 44C of the third pawl 40C.

The third cam portion 57 has the same structure as the second cam portion 56.

The spiral spring 60 biases the cam 50 in a predetermined rotation direction (hereafter referred to as the biasing direction RB) relative to the first bracket 21. That is, basing force is applied to rotate the cam 50 in the biasing direction RB.

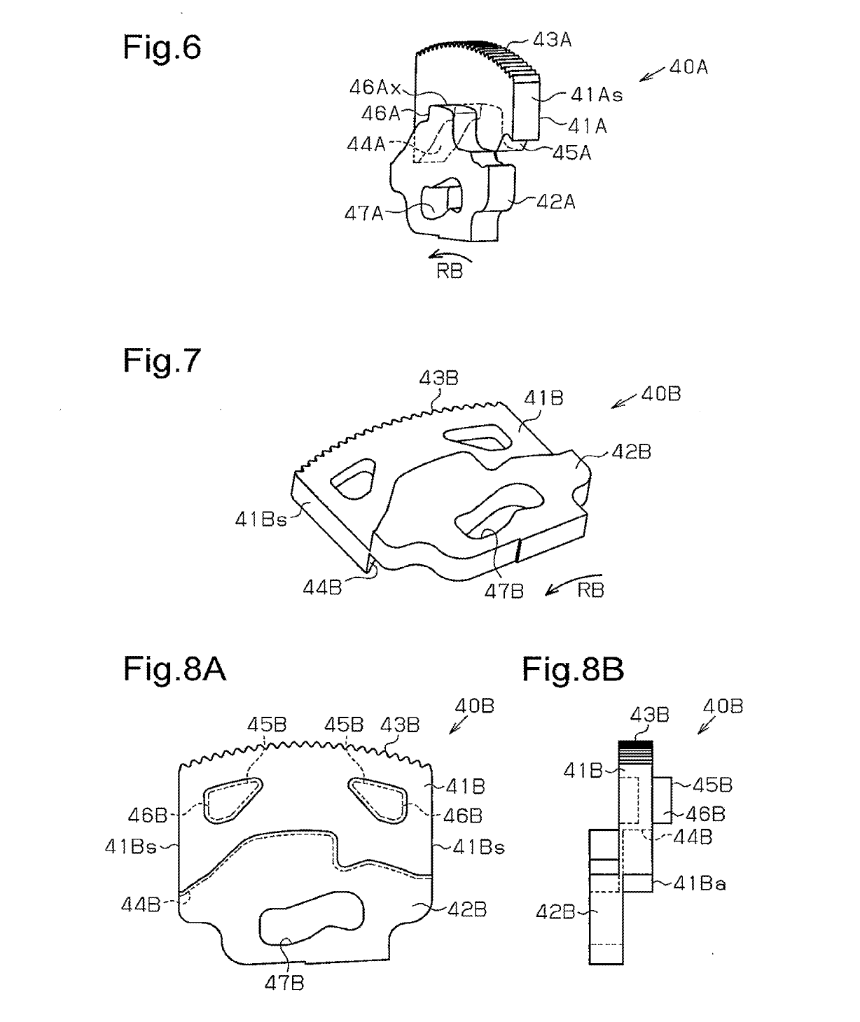

The first pawl 40A will now be described with reference to FIG. 6.

The first pawl 40A includes a first block 41A and a second block 42A that are arranged in different stages. The first block 41A is arranged toward the outer side in the radial direction, and the second block 42A is arranged toward the inner side in the radial direction (refer to FIG. 2).

The first block 41A is attached to a guide groove 26.

The first block 41A is arranged at the same position as the cam 50 in the direction of the rotation axis C2 (refer to FIG. 2).

The first block 41A has a radially outer end surface (end surface opposing inner teeth 37 of second bracket 31, which will be described later) that is configured to be arcuate and includes outer teeth 43A that are engaged with the inner teeth 37 of the second bracket 31.

The first block 41A has a radially inner end surface (end surface opposite to radially outer end surface) that defines a first cam surface 44A, which contacts the first cam portion 55 of the cam 50.

The radially inner end surface of the first block 41A includes a concavity 45A that is continuous from the first cam surface 44A and accommodates the ball cam 90. The ball cam 90 is accommodated in a ball cam accommodation compartment formed by the concavity 45A of the first pawl 40A, the first cam portion 55 of the cam 50, and the guide surface 24 of the guide 23 (refer to FIG. 10A).

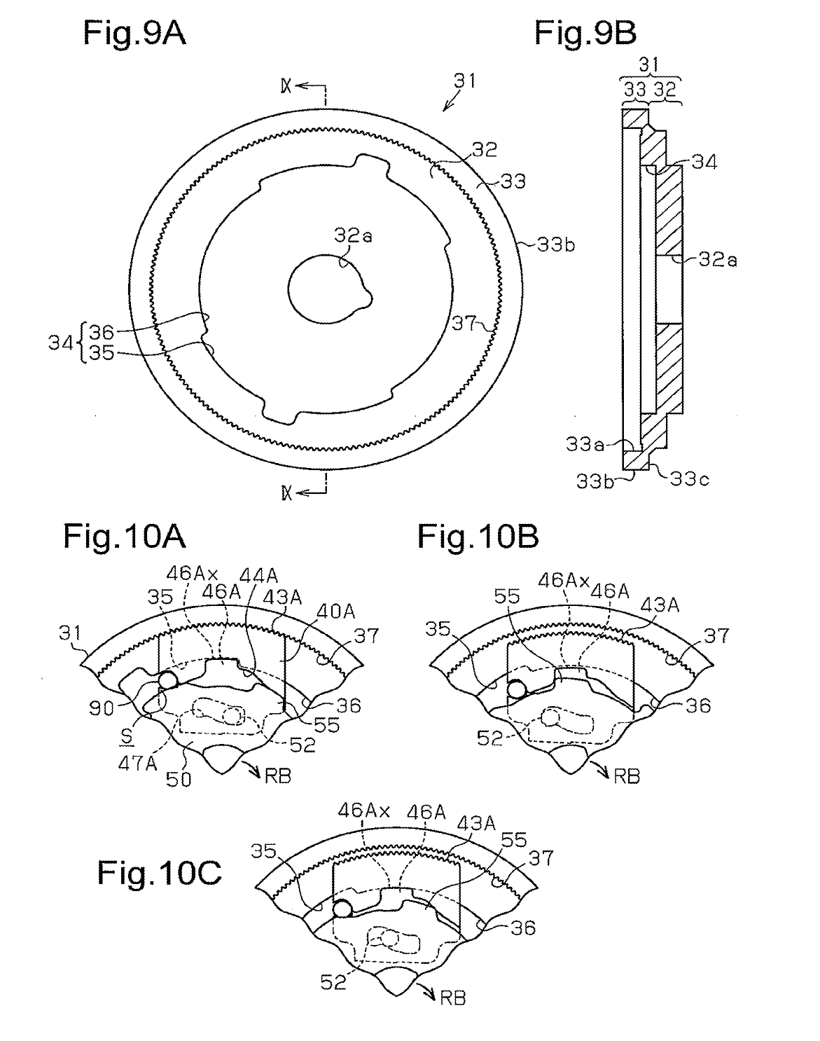

The second block 42A is arranged opposing the first surface 50a of the cam 50. That is, the second block 42A is arranged between the cam 50 and the second bracket 31 in the direction of the rotation axis C2 (refer to FIG. 2). The second block 42A is arranged so that the radially outer end surface of the second block 42A opposes an outer circumferential portion 35 or an inner circumferential portion 36 of the second bracket 31 (refer to FIG. 9A), which will be described later.

The radially outer end surface of the second block 42A defines a restriction portion 46A that contacts the inner circumferential portion 36 of the second bracket 31 and restricts movement of the first pawl 40A toward the outer side in the radial direction.

A cam hole 47A extends in the thickness-wise direction through the central portion of the second block 42A. The cam hole 47A is configured to be elongated in the circumferential direction and extended in the biasing direction RB toward the inner side in the radial direction (refer to FIG. 6). One of the pawl engagement portions 52 of the cam 50 is inserted into the cam hole 47A.

The second pawl 40B will now be described with reference to FIGS. 7, 8A, and 8B.

FIG. 7 is a perspective view of the second pawl 40B. FIG. 8A is a plan view of the second pawl 40B. FIG. 8B is a side view of FIG. 8A. The third pawl 40C has the same structure as the second pawl 40B. Thus, the third pawl 40C will not be described.

The second pawl 40B includes a first block 41B and a second block 42B that are arranged in different stages. The first block 41B is arranged toward the outer side in the radial direction, and the second block 42B is arranged toward the inner side in the radial direction.

The first block 41B is attached to a guide groove 26.

The first block 41B is arranged at the same position as the cam 50 in the direction of the rotation axis C2.

The first block 41B has a radially outer end surface (end surface opposing inner teeth 37 of second bracket 31) that is configured to be arcuate and includes outer teeth 43A that are engaged with the inner teeth 37 of the second bracket 31. The first block 41b has a radially inner end surface (end surface opposite to radially outer end surface) that defines a second cam surface 44B, which contacts the second cam portion 56 of the cam 50.

The first block 41B includes the contact portion 45B that is configured as described below.

If the second pawl 40B moves in the circumferential direction (e.g., when plastic deformation moves the second pawl 40B in the circumferential direction relative to the first bracket 21), the contact portion 45B contacts the restriction portion 27 of the first bracket 21.

The contact portion 45B is arranged on the outer surface 41Ba of the first block 41B (surface opposing first bracket 21, refer to FIGS. 3 and 8A) so as to project from the outer surface 41Ba. There may be only one contact portion 45B. In the present embodiment, there are two contact portions 45B.

The two contact portions 45B are arranged in the circumferential direction. Each contact portion 45B includes the contact surface 46B that is directed toward the outer side of the first block 41B in the circumferential direction. Each contact surface 46B is configured to be parallel to the side surfaces 41Bs of the second pawl 40B.

The two contact portions 45B are accommodated in the corresponding restriction portion 27, which has a recess structures, of the first bracket 21. In the accommodated state, the contact surface 46B (first contact surface) of one of the contact portions 45B is arranged opposing the first wall surface 27a of the restriction portion 27, and the contact surface 46B (second contact surface) of the other one of the contact portions 45B is arranged opposing the second wall surface 27b of the restriction portion 27. The distance d1 between the contact surfaces 46B of the contact portions 45B and the corresponding wall surfaces 27a and 27b of the restriction portion 27 is set to be greater than the distance d2 between the side surfaces 41Bs of the second pawl 40B and the corresponding guide surfaces 24 (refer to FIG. 12). That is, in the normal state (when excessive rotation force is not applied to the second bracket 31), the contact portion 45B is spaced apart from the first wall surface 27a (or second wall surface 27b) of the restriction portion 27.

The distance d1 between the contact surfaces 46B of the contact portions 45B and the corresponding wall surfaces 27a and 27b of the restriction portion 27 is set so that the contact surface 46B and the first wall surface 27a contact each other when excessive force of an impact or the like plastically deforms the second pawl 40B and moves the second pawl 40B in the circumferential direction (when second pawl 40B moves relative to first bracket 21 in circumferential direction).

The second block 42B is arranged opposing the first surface 50a of the cam 50. That is, the second block 42B is arranged between the cam 50 and the second bracket 31 in the direction of the rotation axis C2.

A cam hole 47B extends in the thickness-wise direction through the central portion of the second block 42A. The cam hole 47B is configured to be elongated in the circumferential direction and extended in the biasing direction RB toward the inner side in the radial direction (refer to FIG. 7). One of the pawl engagement portions 52 of the cam 50 is inserted into the cam hole 47B.

The second bracket 31 will now be described with reference to FIGS. 9A and 9B.

As shown in FIGS. 9A and 9B, the second bracket 31 includes a main body 32 and an outer circumferential wall 33. The main body 32 is disk-shaped and includes an insertion hole 32a through which the shaft 5 is inserted. The outer circumferential wall 33 extends from the outer edge of the main body 32 toward the outer side in the radial direction.

The outer circumferential wall 33 has an inner circumferential surface 33a. The inner teeth 37 are arranged on the entire circumference of the inner circumferential surface 33a and engage the outer teeth 43A to 43C of the first to third pawls 40A to 40C.

The outer circumferential wall 33 has an outer circumferential surface 33b that comes into contact with and slides on the retainer 80. The outer circumferential wall 33 has an outer surface 33c that comes into contact with and slides on a projection 83 of the retainer 80 (refer to FIG. 2), which will be described later.

The central portion of the main body 32 includes a circular recess 34.

The recess 34 includes a plurality of outer circumferential portions 35, each having a circumferential surface of a predetermined first radius, and a plurality of inner circumferential portions 36, each having a circumferential surface of a second radius that is smaller than the first radius. That is, when a circumferential surface having the same first radius as the outer circumferential portion 35 serves as a reference surface, each inner circumferential portion 36 projects toward the inner side in the radial direction from the reference surface. That is, each inner circumferential portion 36 extends in the circumferential direction radially inward from the outer circumferential portions 35.

The structure of each outer circumferential portion 35 will now be described.

Referring to FIG. 10A, the circumferential surface of the outer circumferential portion 35 is located toward the outer side in the radial direction from where an end surface 46Ax of the restriction portion 46A of the first pawl 40A is located when the first pawl 40A is moved to the radially outermost position (i.e., when outer teeth 43A of first pawl 40A is engaged with inner teeth 37 of second bracket 31).

Thus, when the rotation of the second bracket 31 arranges the outer circumferential portion 35 at a location corresponding to the restriction portion 46A of the first pawl 40A, there is no restriction to the movement of first pawl 40A in the radial direction. Thus, when the outer circumferential portion 35 is located at this position, the first pawl 40A is also allowed to move to the outermost position.

The structure of each inner circumferential portion 36 will now be described.

Referring to FIG. 10A, the circumferential surface of the inner circumferential portion 36 is located toward the inner side in the radial direction from where an end surface 46Ax of the restriction portion 46A of the first pawl 40A is located when the first pawl 40A is moved to the radially outermost position (i.e., when outer teeth 43A of first pawl 40A is engaged with inner teeth 37 of second bracket 31).

Thus, when the rotation of the second bracket 31 arranges the inner circumferential portion 36 at a location corresponding to the restriction portion 46A of the first pawl 40A, the restriction portion 46A of the first pawl 40A contacts the inner circumferential portion 36. When the inner circumferential portion 36 is located at this position, movement of the first pawl 40A toward the outer side in the radial direction is restricted.

The structure of the retainer 80 will now be described.

As shown in FIGS. 2 and 3, the retainer 80 includes an annular main body 81 and a flange 82 that extends from one of the edges of the main body 81 toward the central portion. The flange 82 includes the projection 83 that projects toward the inner side (toward second bracket 31). The projection 83 adjusts play (allowance) for movement of the second bracket 31 in the direction of the rotation axis C2.

The main body 81 of the retainer 80 surrounds the outer circumferential surface 22c of the first bracket 21 and the outer circumferential surface 33b of the second bracket 31. The main body 81 of the retainer 80 is laser-welded to the outer circumferential surface 22c of the first bracket 21. The flange 82 of the retainer 80 covers the outer surface 33c of the outer circumferential wall 33 of the second bracket 31 (refer to FIG. 2). Thus, the retainer 80 holds the first bracket 21 and the second bracket 31 maintaining the distance between the first bracket 21 and the second bracket 31 at a predetermined distance in the direction of the rotation axis C2.

With reference to FIGS. 10A to 10C, the operation of the seat reclining device 20 will now be described.

FIGS. 10A to 10C are each schematic diagrams corresponding to a cross-sectional position lying along line X-X in FIG. 2 showing different operational states of the seat reclining device 20. The guides 23 and the retainer 80 are not shown in FIGS. 10A to 10C.

FIG. 10A shows the outer teeth 43A of the pawls 40A to 40C engaged with the inner teeth 37 of the second bracket (hereinafter, referred to as the locked state).

FIG. 10B shows the outer teeth 43A to 43C of the pawls 40A to 40C disengaged from the inner teeth 37 of the second bracket 31 by maintaining the pawls 40A to 40C at positions located toward the inner side in the radial direction (hereinafter, referred to as the unlocked state).

FIG. 10C shows the outer teeth 43A to 43C of the pawls 40A to 40C disengaged from the inner teeth 37 of the second bracket 31 by restricting radially outward movement of the first pawl 40A (hereinafter, referred to as the lock-disabled state).

The seat reclining device 20 includes the next two basic operations.

The first basic operation is the operation of the pawls 40A to 40C resulting from the rotation of the cam 50.

The second basic operation is the restriction of movement of the pawls 40A to 40C when the second bracket 31 rotates.

An example of the first basic operation will now be described using the first pawl 40A.

The cam 50 is biased to rotate in the biasing direction RB. When the cam 50 rotates in the biasing direction RB, the first cam portion 55 pushes the first cam surface 44A of the first pawl 40A. This moves the first pawl 40A toward the outer side in the radial direction. As shown in FIG. 10A, when the outer teeth 43A of the first pawl 40A is engaged with the inner teeth 37 of the second bracket 31, the first cam portion 55 pushes the first pawl 40A toward the outer side in the radial direction. This fixes the second bracket 31 to the first bracket 21. In this state, the seat reclining device 20 is locked.

When the operation of the operation lever 5a rotates the cam 50 in a direction opposite to the biasing direction RB, the wall surface of the cam hole 47A is pushed by the corresponding pawl engagement portion 52 of the cam 50. This moves the first pawl 40A toward the inner side in the radial direction. As shown in FIG. 10B, this separates the inner teeth 37 of the second bracket 31 from the outer teeth 43A of the first pawl 40A. Thus, the second bracket 31 becomes rotatable relative to the first bracket 21. In this state, the seat reclining device 20 is unlocked.

The second basic operation will now be described.

As shown in FIG. 10C, if the operation lever 5a is released when the inner circumferential portion 36 of the second bracket 31 is located at a position corresponding to the restriction portion 46A of the first pawl 40A, the cam 50 rotates in the biasing direction RB. The rotation of the cam 50 moves the first pawl 40A toward the outer side in the radial direction. However, the restriction portion 46A of the first pawl 40A contacts the inner circumferential portion 36. This restricts movement of the first pawl 40A before reaching the radially outermost position. That is, movement of the first pawl 40A toward the outer side in the radial direction is restricted. This keeps the inner teeth 37 of the second bracket 31 separated from the outer teeth 43A of the first pawl 40A. Further, contact of the restriction portion 46A of the first pawl 40A with the inner circumferential portion 36 of the second bracket 31 restricts rotation of the cam 50. Thus, the other pawls (second and third pawls 40B and 40C) are also maintained in a state in which the outer teeth 43B and 43C are separated from the inner teeth 37 of the second bracket 31. In this manner, when the inner circumferential portion 36 of the second bracket 31 is located at a position corresponding to the restriction portion 46A of the first pawl 40A, the locking of the seat reclining device 20 is restricted. Thus, the seat reclining device 20 is in a state in which locking is disabled (rotation of second block 31 is allowed).

The operation of the cam mechanism in each state of the seat reclining device 20 will now be described.

In the locked state shown in FIG. 10A, the seatback 4 is inclined relative to the seat cushion 3 by an angle that is within a predetermined range. In this state, the seat reclining device 20 is in a mode in which the operation lever 5a is not operated.

When the seatback 4 is inclined relative to the seat cushion 3 by an angle that is within a predetermined range, that is, when the outer circumferential portion 35 of the second bracket 31 is located at a position corresponding to the restriction portion 46A of the first pawl 40A, there is no restriction to the movement of the first pawl 40A in the radial direction.

When the operation lever 5a is not operated, that is, when force in a direction opposite to the biasing direction RB is not applied to the cam 50, the biasing force applied to the cam 50 rotates the cam 50 in the biasing direction RB. Thus, the first to third cam portions 55 to 57 respectively push the first to third cam surfaces 44A to 44C of the pawls 40A to 40C. This pushes the pawls 40A to 40C toward the outer side, and the outer teeth 43A of the pawls 40A to 40C engage the inner teeth 37 of the second bracket 31. Thus, the seat reclining device 20 is in the locked state.

Some of the pushing force produced by the rotation of the cam 50 is applied to the first pawl 40A by the ball cam 90. Thus, the ball cam 90 pushes the first pawl 40A and the guide 23. This limits unnecessary movement of the first pawl 40A produced in the gap between the side surface 41As of the first pawl 40A and the guide surface 24.

The unlocked state shown in FIG. 10B is the mode of the reclining device 20 when the operation lever 5a is being operated.

When the operation of the operation lever 5a rotates the cam 50 in a direction opposite to the biasing direction RB, the first basic operation moves the pawls 40A to 40C toward the inner side in the radial direction and separates the inner teeth 37 of the second bracket 31 from the outer teeth 43A to 43C of the pawls 40A to 40C. This shifts the seat reclining device 20 to the unlocked state.

In the lock disabled state shown in FIG. 10C, the seat reclining device 20 is in a mode in which the seatback 4 is inclined relative to the seat cushion 3 by an angle outside the predetermined range. Further, the operation lever 5a is not being operated.

When the seatback 4 is inclined relative to the seat cushion 3 by an angle outside the predetermined range, that is, when the inner circumferential portion 36 of the second bracket 31 is located at a position corresponding to the restriction portion 46A of the first pawl 40A, the second basic operation restricts movement of the first pawl 40A toward the outer side in the radial direction. Thus, the seat reclining device 20 is in the lock-disabled state.

An impact may be applied to the seat reclining device 20.

For example, when a still vehicle is hit from the rear by another vehicle, inertia causes the vehicle occupant to be forced toward the rear. This applies a strong rotation force (torque) to the seatback 4 that acts to incline the seatback 4 toward the rear.

When impact force is applied to the seat reclining device 20 that is in the locked state, the second bracket 31 acts to rotate in the direction in which the impact force is applied. In this case, rotation force is applied to the pawls 40A, 40B, and 40C that are engaged with the second bracket 31. However, the rotation of the pawls 40A, 40B, and 40C is restricted by the guides 23. This restricts rotation of the second bracket 31.

When the impact force applied to the seat reclining device 20 is large, a large reaction force is applied by the guides 23 to the pawls 40A, 40B, and 40C. Thus, although the pawls 40A, 40B, and 40C are elastically deformed and moved in the circumferential direction, the elastic deformation simultaneously reduces the impact force and restricts rotation of the second bracket 31.

However, when the impact force applied to the seat reclining device 20 is excessive, the reaction force of the guides 23 resulting from the impact force becomes excessive and the deformation amount of the pawls 40A, 40B, and 40C becomes relatively large. This may cause plastic deformation of the pawls 40A, 40B, and 40C. Plastic deformation of the pawls 40A, 40B, and 40C hinder smooth movement of the pawls 40A, 40B, and 40C in the radial direction.

Therefore, the seat reclining device 20 of the present embodiment includes an impact force dispersion mechanism to reduce plastic deformation of the pawls 40A, 40B, and 40C when such an excessive impact force is applied. The impact force dispersion mechanism includes the contact portions 45B and the restriction portions 27 and will now be described in further detail.

Referring to FIGS. 11 and 12, the operation of the impact force dispersion mechanism when impact is applied to the seat reclining device 20 will now be described using the second pawl 40B as an example. The impact force dispersion mechanism of the second pawl 40B functions in the same manner as the impact force dispersion mechanism of the third pawl 40C.

When, for example, the vehicle is hit from the rear and a strong force that acts to incline the seatback 4 toward the rear applies rotation force (torque) to the second bracket 31 in the rear rotation direction RX, the force is transmitted to the second pawl 40B through the portion where the inner teeth 37 of the second bracket 31 is engaged with the outer teeth 43B of the second pawl 40B. That is, when rotation force (torque) is applied to the second bracket 31 in the reverse direction RX, movement force is applied to the second pawl 40B in the circumferential direction. Thus, referring to FIG. 11, the second pawl 40B pushes the guide surface 24 of the guide 23.

When the impact applied to the seat reclining device 20 is small and the rotation force (torque) applied to the second bracket 31 is not large, the guide 23 restricts movement of the second pawl 40B in the circumferential direction. This keeps the contact portions 45B of the second pawl 40B spaced apart from the first wall surface 27a of the restriction portion 27.

When the impact applied to the seat reclining device 20 is excessive and the rotation force (torque) of the second bracket 31 is large, the force of the second pawl 40B that pushes the guide 23 increases. As a result, the reaction force from the guide 23 increases. This elastically deforms the second pawl 40B and moves the second pawl 40B in the circumferential direction (more specifically, second pawl 40B moves relative to first bracket 21 in circumferential direction). Thus, the contact portion 45B (contact surface 46B) of the second pawl 40B contacts the first wall surface 27a.

Referring to FIG. 12, the second pawl 40B transmits force, which is transmitted from the second bracket 31, through the contact surface 46B of the contact portion 45B (first contact surface) and the side surface 41Bs of the second pawl 40B to the restriction portion 27 and the guide 23 of the first bracket 21. As a result, the second pawl 40B receives reaction force from the restriction portion 27 and the guide 23. That is, the second pawl 40B disperses and transmits the force from the second bracket 31 to the first bracket 21. Further, the second pawl 40B receives the reaction force resulting from the transmission of the impact force with a wider area than the pawl of the prior art structure. This limits plastic deformation of the second pawl 40B.

A case in which the second bracket 31 is rotated in the reverse rotation direction RX by the impact force of a crash or the like is described above. However, the seat reclining device 20 functions in the same manner when the second bracket 31 rotates in a direction opposite to the reverse rotation direction RX.

For example, when the vehicle hits an obstacle head-on, a vehicle occupant on a rear seat may be forced toward the front, and the vehicle occupant on the rear seat may push the seatback 4 toward the front with a strong force. In this case, the second bracket 31 fixed to the seatback 4 is rotated in a direction opposite to the reverse rotation direction RX. When the impact force is excessive, the contact portion 45B (contact surface 46B (second contact surface)) of the second pawl 40B contacts the second wall surface 27b of the restriction portion 27. This limits plastic deformation of the second pawl 40 because of the reasons described above.

The pawls 40A, 40B, and 40C contact the cam 50. Thus, the impact force is transmitted by the cam 50 to the shaft 5.

The seat reclining device 20 of the present embodiment has the advantages described below.

(1) In the embodiment, the first bracket 21 includes the guides 23 that guide the second pawl 40B in the radial direction and the restriction portion 27 that restricts movement of the second pawl 40B in the circumferential direction. The second pawl 40B includes two contact portions 45B that are spaced apart by a gap from the corresponding restriction portion 27. Each contact portion 45B contacts the restriction portion 27 when the second pawl 40B moves in the circumferential direction (movement resulting from impact).

Thus, when pivoting of the seatback 4 applies excessive force to the second pawl 40B, the second pawl 40B pushes the guide 23. Further, the second pawl 40B pushes the restriction portion 27 with the contact portion 45B. Here, the second pawl 40B receives reaction force from the restriction portion 27 and the guide 23 with a larger area than the pawl of the prior art structure. This limits plastic deformation of the second pawl 40B. The same effect is produced by the impact dispersion mechanism of the third pawl 40C.

The seat reclining device 20 has a tendency to be reduced in size in the radial direction and the thickness-wise direction (direction of rotation axis C2). The impact force dispersion mechanism is applied to such a seat reclining device 20. In the seat reclining device 20 that has smaller dimensions in the radial direction and the thickness-wise direction than the prior art, each of the pawls 40A to 40C is thin or short, and the area of contact between each of the pawls 40A to 40C and the corresponding guide 23 is small. This lowers the impact resistance as compared with the prior art. To cope with this, the impact force dispersion mechanism of the above structure is applied to the seat reclining device 20. This limits decreases in the impact resistance.

(2) In the above embodiment, the impact force dispersion mechanism is formed by the contact portions 45B and the restriction portion 27. The restriction portion 27 has a recess structure. Each contact portion 45B, which projects from the second pawl 40B, is accommodated in the corresponding restriction portion 27. Thus, the impact force dispersion mechanism is more compact than a structure in which the restriction portion and the contact portion of the impact force dispersion mechanism both have a projection structure. Thus, enlargement of the seat reclining device 20 is limited even when employing the impact force dispersion mechanism.

(3) In the above embodiment, the first bracket 21 includes the projections 27x that project from the outer surface 22b of the first bracket 21 in correspondence with the restriction portions 27.

In this configuration, the projections 27x, which project from the outer surface 22b of the first bracket 21 in correspondence with the restriction portions 27, can be used as coupling portions of the first bracket 21. This simplifies the structure of the first bracket 21 as compared with when a projection serving as a coupling portion of the first bracket 21 is provided at a portion that differs from the portion corresponding to the restriction portion 27.

This configuration indicates that when the projection 27x serving as a coupling portion is provided on the outer surface 22b of the first bracket 21, the recess in the inner surface 22a of the first bracket 21 corresponding to the projection 27x can be used as the restriction portion 27. Thus, in the seat reclining device 20 that originally had the projection 27x serving as the coupling portion on the first bracket 21, the impact force dispersion mechanism can be formed without the need to provide a separate restriction portion 27 having a recess structure. In the above embodiment, the recess corresponding to the projection 27x accommodates the contact portions 45B. Thus, the seat reclining device 20 has a thickness-wise dimension (dimension in direction of rotation axis C2) that is the same as the prior art structure that does not include the impact force dispersion mechanism.

(4) In the above embodiment, the first wall surface 27a (restriction surface) and the second wall surface 27b (restriction surface) of the restriction portion 27 are configured to extend in the movement direction Dr of the second pawl 40B that moves in the radial direction. Further, the first wall surface 27a is configured to be parallel to the contact surface 46B of the contact portion 45B, and the second wall surface 27b is configured to be parallel to the contact surface 46B of the contact portion 45B.

Movement of the second pawl 40B in the radial direction changes the positional relationship of the contact surface 46B (first contact surface) of the contact portion 45B of the second pawl 40B and the first wall surface 27a of the restriction portion 27 and the positional relationship of the contact surface 46B (second contact surface) and the second wall surface 27a. Thus, when the second pawl 40B moves in the radial direction, the contact portion 45B of the second pawl 40B may contact the first wall surface 27a (or second wall surface 27b) depending on the configuration of the first wall surface 27a (or second wall surface 27b) of the restriction portion 27. This hinders smooth movement of the second pawl 40B.

In this respect, in the above structure, the first wall surface 27a and the second wall surface 27b are configured as surfaces extending in the movement direction Dr of the second pawl 40B that moves in the radial direction (refer to FIG. 11). Further, the first wall surface 27a (or second wall surface 27b) and the contact surface 46B are configured to be parallel to each other. Thus, even when the second pawl 40B moves, the first wall surface 27a (or second wall surface 27b) and the contact surface 46B remain parallel to each other. That is, movement of the second pawl 40B in the radial direction does cause the first wall surface 27a (or second wall surface 27b) to slide on the contact surface 46B. Thus, the movement of the second pawl 40B remains smooth.

Further, this configuration has the next effect. When impact or the like moves the second pawl 40B in the circumferential direction, the contact portion 45B contacts the first wall surface 27a (or second wall surface 27b) of the restriction portion 27. In the above configuration, this results in planar contact of the two portions. Thus, compared with when two portions come into plane-and-point contact or plane-and-line contact, concentration of impact force at one portion is limited. This further limits plastic deformation of the second pawl 40B. The relationship of the third pawl 40C and the corresponding restriction portion 27 also has the same effect.

(5) In the above embodiment, the restriction portion 27 is a recess including the first and second wall surfaces 27a and 27b (restriction surfaces) that are located at different positions in the circumferential direction and opposed to each other. The contact portions 45B each include the contact surface 46B (first contact surface) that is arranged opposing the first wall surface 27a (one restriction surface) of the restriction portion 27 and the contact surface 46B (second contact surface) that is arranged opposing the second wall surface 27b (other restriction surface) of the restriction portion 27.

More specifically, the contact surfaces 46B are arranged respectively for the first and second wall surfaces 27a and 27b (restriction surfaces) that are located at different positions in the circumferential direction. Thus, even when the second pawl 40B moves in any circumferential direction, the contact portion 45B and the restriction portion 27 come into contact. This limits plastic deformation of the second pawl 40B regardless of the direction impact force is applied to the second bracket 31 (reverse rotation direction RX or direction opposite to the reverse rotation direction).

(6) In the above embodiment, the distance d1 between the restriction portion 27 and the contact portion 45B (first contact surface of second contact surface) is greater than the distance d2 between the guide groove 26 and the second pawl 40B, which is guided by the guide groove 26.

In this configuration, when the distance d1 between the restriction portion 27 and the contact portion 45B is equal to the distance d2 between the guide groove 26 and the second pawl 40B, which is guided by the guide groove 26, the restriction portion 27 may contact the contact portion and hinder movement of the second pawl 40B in the radial direction. In this respect, the restriction portion 27 of the first bracket 21 and the contact portion 45B of the second pawl 40B seldom come into contact with each other. Thus, there is no decrease in the smoothness of the movement of the second pawl 40B in the radial direction.

The above embodiment may be modified as described below.

In the above embodiment, the second pawl 40B includes the two contact portions 45B. However, one of the contact portions 45B may be omitted. In this case, advantage (1) is obtained in only the direction in which the contact portion 45B and the restriction portion 27 contact each other.

In the above embodiment, the second pawl 40B includes the two contact portions 45B. However, the two contact portions 45B may be integrated and configured as a single contact portion. In this case, the contact portion extends in the circumferential direction. Further, one circumferential surface (first contact surface) is opposed to the first wall surface 27a of the restriction portion 27, and the other circumferential surface (second contact surface) is opposed to the second wall surface 27b.

In the above embodiment, the first bracket 21 includes the restriction portion 27 that has a recess structure, and the second pawl 40B includes the contact portion 45B that projects from the outer surface 41Ba. However, the restriction portion 27 and the contact portion 45B may be shaped differently. More specifically, the first bracket 21 may include a restriction portion 27 that has a projection structure, and the second pawl 40B may include a contact portion 45B that is recessed in the outer surface 41Ba. In this case, the contact portion 45B has a recess structure or a through hole structure. This configuration also obtains advantage (1).

As shown in FIG. 13, instead of the restriction portion 27 of the embodiment, the first bracket 21 may include an accommodation portion 120 that has a recess structure, and a restriction portion 127 may project from the bottom surface of the accommodation portion 120. In this case, the contact portion 145 of the second pawl 40B is configured as a projection that enters the gap between the accommodation portion 120 and the restriction portion 127. In this configuration, when impact or the like rotates the second bracket 31 and moves the second pawl 40B in the circumferential direction, the contact portion 145 contacts the restriction portion 127. This limits plastic deformation of the second pawl 40B.

In the above embodiment, the first pawl 40A does not include the contact portion of the impact force dispersion mechanism. However, the first pawl 40A may include the contact portion. Nevertheless, the first pawl 40A includes the restriction portion 46A that contacts the inner circumferential portion 36 of the second bracket 31. Thus, when the dimension of the first pawl 40A in the radial direction is not sufficiently long, it is difficult to form the contact portion 45B through stamping. In this case, the first pawl 40A that includes the contact portion is formed through forging, machining, or the like.

In the above embodiment, the reverse rotation direction RX of the second bracket 31 when the seatback 4 is inclined toward the rear coincides with the biasing direction RB of the cam 50. However, the two directions do not have to coincide with each other. That is, the reverse rotation direction RX of the second bracket 31 when the seatback 4 is inclined toward the rear may be opposite to the biasing direction RB of the cam 50.

In the above embodiment, the three pawls 40A, 40B, and 40C are arranged in the first bracket 21. However, there is no limit to the number of pawls. Further, when multiple pawls are used, the pawls may be shaped differently from each other or identically with each other as long as they are configured to move in cooperation with each other.

In the above embodiment, the first bracket 21 is fixed to the seat cushion 3, and the second bracket 31 is fixed to the seatback 4. However, the arrangement of the brackets 21 and 31 may be reversed. That is, the first bracket 21 may be fixed to the seatback 4, and the second bracket 31 may be fixed to the seat cushion 3.

1. A seat reclining device comprising:
a first bracket;
a second bracket that is rotatable relative to the first bracket;
a cam that is rotatable relative to the first bracket; and
pawls moved in a radial direction of the first bracket and engaged with the second bracket by rotation of the cam, wherein
the first bracket includes a guide, which guides the pawls in the radial direction, and a restriction portion, which is provided in correspondence with at least one of the pawls and which restricts movement of the corresponding pawl in a circumferential direction, and
the pawl corresponding to the restriction portion includes a contact portion that contacts the restriction portion when the pawl moves, wherein the contact portion is spaced apart by a gap from the restriction portion.

2. The seat reclining device according to claim 1, wherein
the restriction portion has a recess structure, and
the contact portion projects from the pawl and is accommodated in the restriction portion.

3. The seat reclining device according to claim 2, wherein the first bracket includes a projection at a location corresponding to the restriction portion, and the projection projects from a surface that is opposite in an axial direction to a surface on which the restriction portion is provided.

4. The seat reclining device according to claim 1, wherein
the restriction portion includes a restriction surface that contacts a contact surface of the contact portion when the pawl moves in the circumferential direction,
the restriction surface is configured as a surface that extends in a movement direction of the pawl, which moves in the radial direction, and
the restriction surface and the contact surface are configured to be parallel to each other.

5. The seat reclining device according to claim 2, wherein
the restriction portion includes a recess including two restriction surfaces that are opposed to each other and located at different positions in the circumferential direction, and
the contact portion of the pawl corresponding to the restriction portion includes a first contact surface that is opposed to one of the restriction surfaces of the restriction portion and a second contact surface that is opposed to the other one of the restriction surfaces of the restriction portion.

6. The seat reclining device according to claim 5, wherein
each of the two restriction surfaces is configured to contact a corresponding one of the first and second contact surfaces when the pawl moves in the circumferential direction,
the two restrictions surfaces are configured as surfaces that extend in a movement direction of the pawl, which moves in the radial direction, and
the two restriction surfaces and the first and second contact surfaces are configured to be parallel to each other.

7. The seat reclining device according to claim 1, wherein distance between the restriction portion and the contact portion is larger than distance between the guide and the pawl.
